(19) United States
(12) Patent Application Publication
(10) Pub. No.: US 2006/0245204 A1
(43) Pub. Date: Nov. 2, 2006

(54) BACKLIGHT UNIT AND LIQUID CRYSTAL DISPLAY DEVICE

(76) Inventor: Minoru Mizuta, Tokyo (JP)

Correspondence Address: SONNENSCHEIN NATH & ROSENTHAL LLP, P.O. BOX 061080, WACKER DRIVE STATION, SEARS TOWER, CHICAGO, IL, 60606-1080, US

(21) Appl. No.: 11/380,238

(22) Filed: Apr. 26, 2006

(30) Foreign Application Priority Data
Apr. 27, 2005 (JP) P2005-130084

(51) Int. Cl. F21V 5/00; F21V 9/00

(52) U.S. Cl. 362/559; 362/231; 362/252

(57) ABSTRACT

A backlight unit having light sources being arranged to be spaced apart from adjacent other light sources in two or more arrangement directions in a plane where the light sources are arranged.

### BACKGROUND OF THE INVENTION

1. Field of the Invention

The present invention relates to a backlight unit for illuminating a liquid crystal display panel from the back thereof, and to a liquid crystal display device using the backlight unit.

2. Description of Related Art

In recent years, instead of CRTs (Cathode Ray Tubes), extremely thin-sized display devices such as liquid crystal display devices (LCDs) and plasma display panels (PDPs) have been proposed and put to practical use as display devices for television sets. Technical research and development are being particularly promoted on liquid crystal display devices using liquid crystal display panels, because the liquid crystal display devices can be driven with low power consumption and are becoming widespread with reductions in price of large-sized liquid crystal display panels.

The majority of such liquid crystal display devices adopt a backlight system which displays a color image by illuminating a transmissive type of liquid crystal display panel equipped with color filters by means of surface emission from the back of the panel. Cold cathode fluorescent lamps (CCFLs), which emit white light by using fluorescent tubes, and light emitting diodes (LEDs) are said to be promising light sources for backlight units.

Light emitting diodes each of which has high monochromaticity and emits any one of the three primary colors of light, i.e., red light, green light and blue light, have been obtained through the development of blue light emitting diodes in particular, so that red light, green light and blue light emitted from these respective light emitting diodes can be mixed to produce white light of high color purity suitable for illumination having high color reproducibility. Accordingly, if such light emitting diodes are used as light sources for a backlight unit, the color purity of a liquid crystal display panel can be increased, so that the color reproduction range thereof can be greatly widened compared to CCFLs. Furthermore, the luminance of the backlight unit can be greatly increased by using a high-power light emitting diode (LED) chip.

Such LEDs have been used to propose, for example, a direct backlight unit in which LEDs are arranged directly below a light emission surface of the backlight unit (refer to, for example, Nikkei Electronics (Nikkei Business Publications, Inc.), Dec. 12, 2004 (No. 889), pp. 123-130).

### SUMMARY OF THE INVENTION

What is important to the above-mentioned backlight unit used in the liquid crystal display device in particular is to uniformly illuminate the liquid crystal display panel. However, it is difficult to uniformly illuminate the entire surface of the liquid crystal display panel, and there is a case where an image of a light source itself becomes visible.

In addition, it is desired that liquid crystal display devices and backlight units be made increasingly smaller in size and thickness, so that it is becoming gradually difficult to uniformly mix lights from LEDs in the case where the LEDs are used as light sources. For example, a construction adopted by an ordinary backlight unit is fabricated by preparing a plurality of long bases each having a wiring structure, rectilinearly arranging light emitting diodes on each of the bases, and juxtaposing the bases in a direction orthogonal to the longitudinal direction thereof, thereby arranging the light emitting diodes in the housing of the backlight unit. In this construction, the interval between each adjacent one of the LEDs is comparatively densely in a direction extending along the long bases, but the interval between each adjacent one of the LEDs is comparatively sparsely in the direction in which the bases are juxtaposed, so that the intervals between adjacent ones of these LEDs greatly differ in different directions in a plane where the LEDs are arranged. As a result, if the backlight unit is reduced in thickness, it is likely that nonuniformity cyclically occurs in luminance and chromaticity, depending on the arrangement of LEDs. In addition, in order to obtain uniform luminance and chromaticity in a thin area such as the inside of the backlight unit, various contrivances are adopted, for example, the angular radiation characteristics of each of the LEDs is made closer to the horizontal direction. However, if the distance between each adjacent one of the LEDs is short, light emitted from each of the LEDs in the horizontal direction directly strikes the adjacent ones and is reflected or diffused, so that unintended luminance nonuniformity and chromaticity distribution may occur.

In view of the above-mentioned circumstances, the present invention is intended to provide a backlight unit and a liquid crystal display device in both of which the arrangement of light sources can be optimized to suppress luminance nonuniformity.

To solve the above-mentioned problems, in accordance with an embodiment of the present invention, there is provided a backlight unit having a construction in which light sources are arranged so that each of the light sources is spaced apart from adjacent other ones of the light sources in two or more arrangement directions in a plane where the light sources are arranged. In accordance with an embodiment of the present invention, in the backlight unit, the light sources are arranged so that the longest distance between each of the light sources and the adjacent other ones of the light sources in the two or more directions is set to a ratio between 1 and 2 relative to the shortest distance therebetween. Furthermore, in accordance with an embodiment of the present invention, in the backlight unit, the light sources include light sources for emitting two or more colors, and each adjacent one of the light sources is arranged to emit a different color. Furthermore, in accordance with an embodiment of the present invention, in the backlight unit in which the light sources include light sources for emitting two or more colors, and from among the light sources for emitting the respective colors, light sources for emitting the same color are approximately cyclically arranged in one or more arrangement direction. Furthermore, in accordance with an embodiment of the present invention, there is provided a liquid crystal display device having a construction using a backlight unit having the present inventive construction mentioned above. More specifically, in a liquid crystal display device including a transmissive type of liquid crystal display panel and a backlight unit for illuminating the liquid crystal display panel on the back side thereof, light sources are arranged in the backlight unit so that each of the light sources is spaced apart from adjacent other ones of the light sources in two or more arrangement directions in a plane where the light sources are arranged.

As mentioned above, in the backlight unit and the liquid crystal display device according to the embodiments of the present invention, the light sources are arranged so that each of the light sources are spaced apart from the adjacent other ones of the light sources in two or more arrangement directions in the plane where the light sources are arranged; that is to say, a desired number of light sources are arranged in a predetermined space in the backlight unit so that each of the light sources is spaced as apart as possible from the adjacent ones in a plurality of directions. Generally, as mentioned above, light sources such as light emitting diodes are arranged comparatively densely in one direction and comparatively sparsely in another direction. On the other hand, in the embodiments of the present invention, light sources are spaced apart from one another in two or more directions so that the light sources are arranged at least equal intervals in a plurality of arrangement directions. In addition, the light sources are arranged so that the longest distance between each of the light sources and the adjacent other ones of the light sources in two or more directions is set to a ratio between 1 and 2 with respect to the shortest distance therebetween. Accordingly, as compared with the related art, the distance between each adjacent ones of the light sources can be made remarkably long, so that luminance uniformity can be improved.

In addition, in the embodiments of the present invention, the light sources include light sources for emitting two or more color lights and each adjacent one of the light sources is arranged to emit a different color, so that color nonuniformity can be satisfactorily suppressed. In addition, in this construction, from among the light sources for emitting different colors, the light sources for emitting the same color are approximately cyclically arranged in one or more arrangement direction, so that each of the light sources can be spaced far more apart from the adjacent ones and the light sources for the same color can be arranged at approximately equal intervals. Accordingly, it is possible to far more reliably improve color uniformity compared to the related art.

In the liquid crystal display device according to the embodiments of the present invention, luminance uniformity and color uniformity can be improved by using the backlight unit, so that the luminance of each of the color light emitting diodes themselves can be increased. Accordingly, it is possible to provide a liquid crystal display device having high luminance and good chromaticity distribution.

As mentioned above, in accordance with the backlight unit and the liquid crystal display device according to the embodiments of the present invention, it is possible to improve luminance uniformity. In addition, in the backlight unit according to the embodiments of the present invention, the light sources include light sources for two or more color lights and each adjacent one of the light sources is arranged to emit a different color, so that luminance uniformity and color uniformity can be improved.

### BRIEF DESCRIPTION OF THE DRAWINGS

The present invention will become more readily appreciated and understood from the following detailed description of embodiments and examples of the present invention when taken in conjunction with the accompanying drawings, in which:

FIG. 1 is a schematic exploded perspective view of the construction of a liquid crystal display device according to an embodiment of the present invention;

FIG. 2 is a schematic plan view of the construction of a main section of a liquid crystal display device according to an embodiment of the present invention;

FIG. 3 is a schematic perspective view of the construction of a main section of a backlight unit according to an embodiment of the present invention;

FIG. 4 is a schematic cross-sectional view of the construction of a liquid crystal display device according to an embodiment of the present invention;

FIG. 5 is a schematic block diagram of a drive circuit for driving a liquid crystal display device according to an embodiment of the present invention;

FIG. 6 is a schematic plan view of the construction of a main section of a backlight unit according to an embodiment of the present invention;

FIG. 7 is a schematic plan view of the construction of a main section of a backlight unit according to an embodiment of the present invention;

FIG. 8 is a schematic plan view of the construction of a main section of a backlight unit according to an embodiment of the present invention;

FIG. 9A is a schematic plan view of the construction of a main section of a backlight unit according to an embodiment of the present invention;

FIG. 9B is a schematic plan view of the construction of a main section of a backlight unit according to an embodiment of the present invention;

FIG. 10A is a schematic plan view of the construction of a main section of a backlight unit according to an embodiment of the present invention;

FIG. 10B is a schematic plan view of the construction of a main section of a backlight unit according to an embodiment of the present invention;

FIG. 11 is a schematic plan view of the construction of a main section of a backlight unit according to an embodiment of the present invention;

FIG. 12 is a schematic plan view of the construction of a main section of a backlight unit according to an embodiment of the present invention; and

FIG. 13 is a schematic plan view of the construction of a main section of a backlight unit according to an embodiment of the present invention.

### DESCRIPTION OF THE PREFERRED EMBODIMENTS

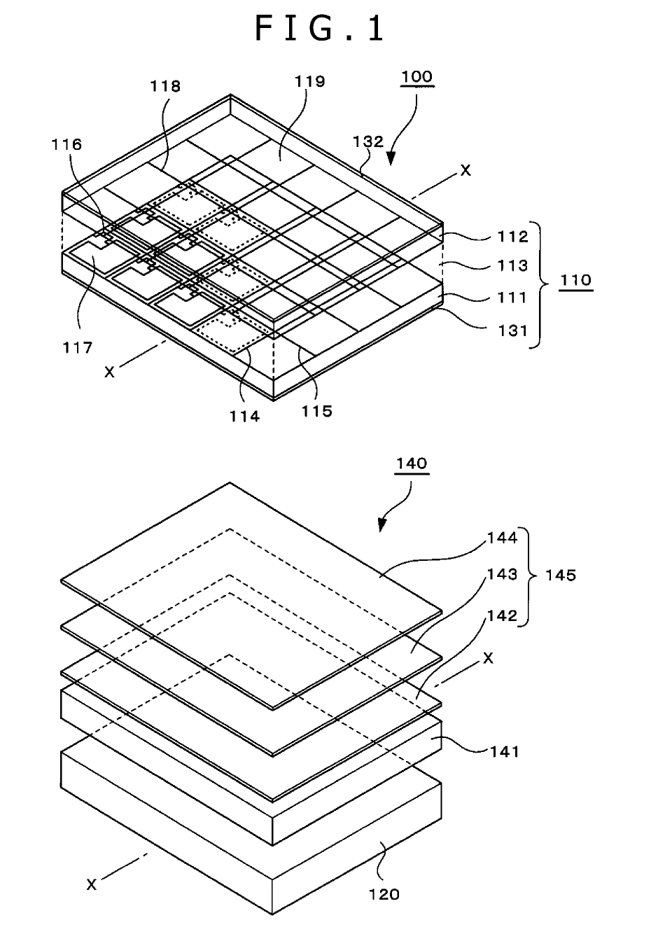

Embodiments of the present invention will be described below in detail with reference to the accompanying drawings, but the present invention is limited to any of the embodiments which will be described later. The present invention can be applied to a transmissive type of color liquid crystal device 100 constructed as shown in FIG. 1 by way of example. The transmissive type of color liquid crystal display device 100 includes a transmissive type of color liquid crystal display panel 110 and a backlight unit 140 provided on the back side of the color liquid crystal display panel 110. Although not shown, the transmissive type of color liquid crystal display device 100 may also be provide with a receiver section, such as an analog tuner or a digital tuner, for receiving terrestrial waves and satellite waves, a video signal processing section and an audio signal processing section for respectively processing a video signal and an audio signal received by the receiver section, and an audio signal output section, such as a speaker, for outputting an audio signal processed by the audio signal processing section.

The transmissive type of color liquid display panel 110 has a construction in which two transparent substrates formed of glass or the like (a TFT substrate 111 and a counter electrode substrate 112) are arranged in opposition to each other and a liquid crystal layer 113 in which, for example, twisted nematic (TN) liquid crystal is sealed is provided between the two transparent substrates. Signal lines 114, scanning lines 115, thin film transistors 116 and pixel electrodes 117 are formed on the TFT substrate 111, and the signal lines 114 and the scanning lines 115 are arranged in matrix form, and the thin film transistors 116 which serve as switching devices are respectively arranged at the intersections of the signal lines 114 and the scanning lines 115. The thin film transistors 116 arranged along each of the scanning lines 115 are sequentially selected by the corresponding one of the scanning lines 115, and the selected ones of the thin film transistors 116 write video signals supplied from the respective ones of the signal lines 114 to the corresponding ones of the pixel electrodes 117. Counter electrodes 118 and a color filter 119 are formed on the inside surface of the counter electrode substrate 112.

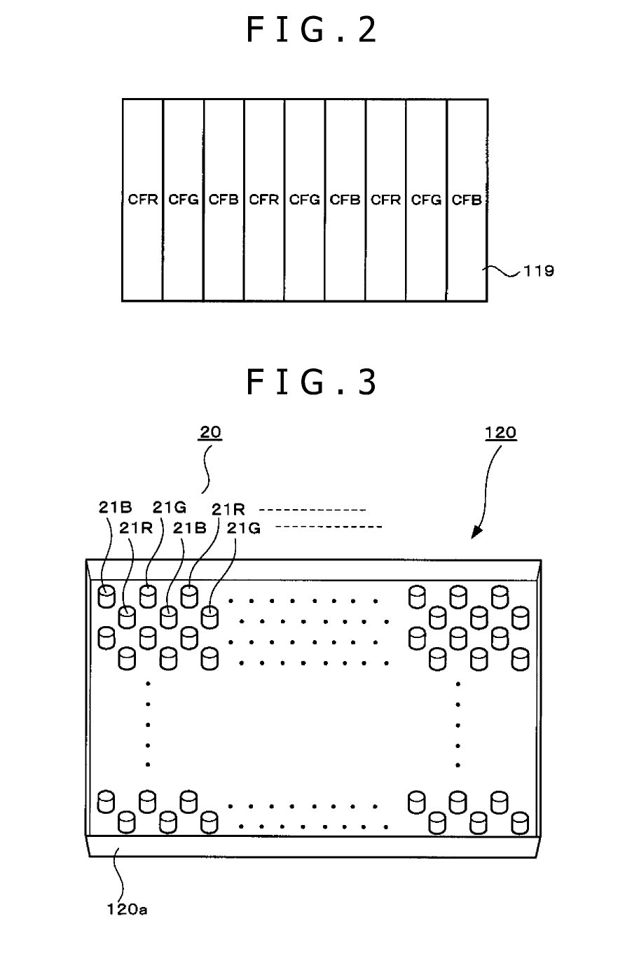

The color filter 119 is divided into a plurality of segments corresponding to the respective pixels. As shown in FIG. 2 by way of example, the color filter 119 is divided into three kinds of segments, i.e., a red filter CFR, a green filter CFG and a blue filter CFB for the three primary colors. Although not shown, the arrangement pattern of the color filter 119 may also be a delta arrangement or a square arrangement in addition to a stripe arrangement such as that shown in FIG. 2.

The construction of the transmissive type of color liquid crystal display device 100 will be further described with reference to FIG. 1. In the transmissive type of color liquid crystal display device 100, the color liquid crystal display panel 110 having the above-mentioned construction is sandwiched between two polarizing plates 131 and 132, and is able to display a desired full color image by being driven by an active matrix method in the state of being illuminated with white light from the back side by the backlight unit 140. The backlight unit 140 illuminates the color liquid crystal display panel 110 from the back side. As shown in FIG. 1, the backlight unit 140 includes light sources none of which is shown in FIG. 1 and a backlight housing 120 in which a diffuser 141 and an optical function sheet group 145 including a diffusion sheet 142, a prism sheet 143 and a polarization conversion sheet 144, all of which are arranged on the diffuser 141 in a stacked manner, are provided in order to mix lights emitted from the respective light sources into white light. The diffuser 141 performs uniformization of luminance in surface emission by internally diffusing light emitted from the backlight housing 120. In general, the optical function sheet group 145 is made of, for example, sheets provided with the function of decomposing entering light into orthogonal polarized components, the function of compensating the phase difference between light waves to realize a wider viewing angle as well as prevention of color changing, the function of diffusing entering light, and the function of realizing an improvement in luminance, and is provided for converting light surface-emitted from the backlight unit 140 into illumination light having optical characteristics optimal for illumination of the color liquid crystal display panel 110. Accordingly, the construction of the optical function sheet group 145 is not limited to the above-mentioned diffusion sheet 142, prism sheet 143 and polarization conversion sheet 144, and can use other various optical function sheets.

FIG. 3 is a schematic view showing the internal construction of the backlight housing 120. As shown in FIG. 3, the backlight unit 140 uses light-emitting diodes as its light sources, but may also use other light sources which are not shown. In the example shown in FIG. 3, the backlight housing 120 uses as light sources 20 red light emitting diodes 21R for emitting red light, green light emitting diodes 21G for emitting green light, and blue light emitting diodes 21B for emitting blue light, and the red light emitting diodes 21R, the green light emitting diodes 21G, and the blue light emitting diodes 21B are arranged in accordance with the construction of any of the embodiments which will be mentioned later. The colors of the light sources 20 are not limited to three colors as in the shown example, and, for example, only white light emitting diodes or two kinds from among red, green and blue light emitting diodes may be used. The peak wavelengths of red light, green light and blue light which are respectively emitted from the red light emitting diodes 21R, the green light emitting diodes 21G, and the blue light emitting diodes 21B are set to, for example, approximately 640 nm, 530 nm and 450 nm, respectively. The peak wavelengths of red light and blue light emitted from the red light emitting diodes 21R and the blue light emitting diodes 21B may also be shifted from 640 nm to a long-wavelength and from 450 nm to a short-wavelength, respectively. If the peak wavelengths are respectively shifted to the long-wavelength and to the short-wavelength in this manner, the color gamut can be widened, so that the color reproduction range of images to be displayed on the color liquid crystal display panel 110 can be enlarged. In the following description, the red light emitting diodes 21R, the green light emitting diodes 21G and the blue light emitting diodes 21B will also be generally referred to as “light emitting diode(s) 21”.

The light emitting diodes 21 may use a side emitting type of diode having the lens function of mainly radiating light in lateral directions, such as an LED chip having the lens shape described in the non-patent document mentioned above in the description of the related art, or an LED chip having the radiation directivity characteristics of other lens shapes. Otherwise, the light emitting diodes 21 may make use of light emitting diodes having radiation directivity characteristics not in lateral directions but in upward directions or obliquely upward directions. An inside wall surface 120a of the backlight housing 120 is a reflection surface processed with reflection treatment for increasing the utilization efficiency of light emitted from the light emitting diodes 21.

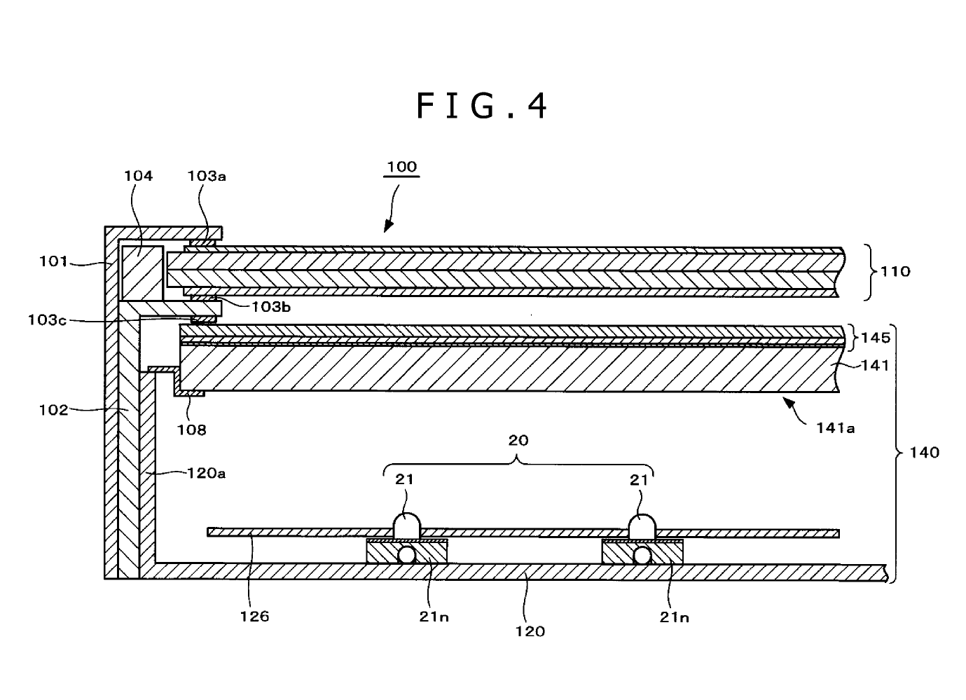

FIG. 4 is a partial cross-sectional view taken along line X-X of FIG. 1, showing the assembled state of the transmissive type of color liquid crystal display device 100. As shown in FIG. 4, the color liquid crystal display panel 110 constituting the color liquid crystal display device 100 is held in such a manner as to be sandwiched via spacers 103a and 103b by an internal frame 102 and an external frame 101 which serves as an outside case of the transmissive type of color liquid crystal display device 100. A guide member 104 is provided between the external frame 101 and the internal frame 102 so that the color liquid crystal display panel 110 sandwiched between the external frame 101 and the internal frame 102 is restrained from deviating in longitudinal directions. The backlight unit 140 constituting the transmissive type of color liquid crystal display device 100 is provided with the diffuser 141 on which the optical function sheet group 145 is stacked as mentioned above. A reflection sheet 126 is provided between the diffuser 141 and the backlight housing 120. The reflection sheet 126 is arranged so that its reflection surface is opposed to a light incident surface 141a of the diffuser 141 and is displaced toward the backlight housing 120 from the emission direction of the light emitting diodes 21. The reflection sheet 126 may use, for example, a silver reflection increasing film formed by stacking a silver reflection film, a low refractive index film and a high refractive index film on a sheet base in named order. In addition, the reflection sheet 126 mainly reflects lights emitted from the light sources 20 such as the light emitting diodes 21 and radiated downwardly according to their angular radiation characteristics, and light reflected from the inside wall surface 120a of the backlight housing 120 which is a reflection surface processed with reflection treatment. The diffuser 141 is held by a bracket member 108 provided on the backlight housing 120.

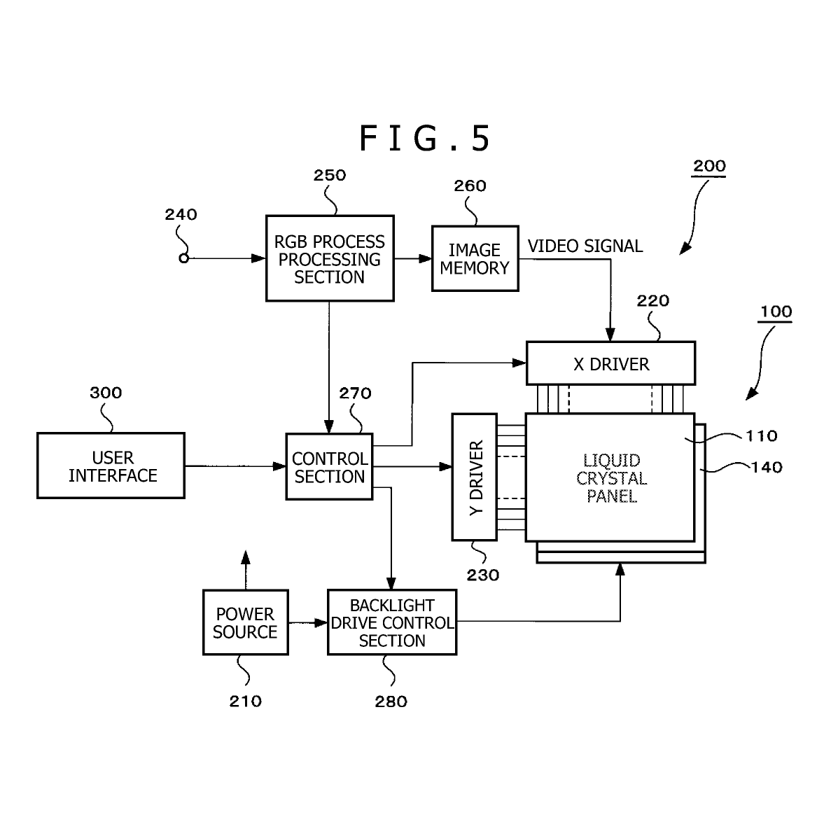

The transmissive type of color liquid crystal display device 100 having the above-mentioned construction is driven by a drive circuit 200 as shown in FIG. 5 by way of example. The drive circuit 200 includes a power source 210 for supplying drive power to the color liquid crystal display panel 110 and the backlight unit 140, an X driver circuit 220 and a Y driver circuit 230 for driving the color liquid crystal display panel 110, an RGB process processing section 250 to which to supply via an input terminal 240 a video signal supplied from the outside and a video signal which is received at a receiver section (not shown) provided in the transmissive type of color liquid crystal display device 100 and is processed at the video signal processing section, an image memory 260 and a control section 270 connected to the RGB process processing section 250, a backlight drive control section 280 for performing drive control of the backlight unit 140, and the like.

In the drive circuit 200, the RGB process processing section 250 performs signal processing such as chroma processing on a video signal inputted via the input terminal 240 and converts the resultant video signal from a composite signal into RGB separate signals suited to driving the color liquid crystal display panel 110, and supplies the RGB separate signals to the control section 270 and to the X driver circuit 220 via the image memory 260. The control section 270 controls the X driver circuit 220 and the Y driver circuit 230 at a predetermined timing according to the RGB separate signals to drive the color liquid crystal display panel 110 with the RGB separate signals supplied to the X driver circuit 220 together with the video signal from the image memory 260, thereby displaying video images corresponding to the RGB separate signals.

The backlight drive control section 280 generates a pulse width modulated (PWM) signal from a voltage supplied from the power source 210 and drives the light emitting diodes 21 which serve as light sources for the backlight unit 140. In general, a light emitting diode has the characteristic that its color temperature depends on operating current. Accordingly, if faithful color reproduction (constant color temperature) is to be effected with the desired luminance obtained, the light emitting diode 21 need be driven by the use of the pulse width modulated signal so as to suppress variations in color. A user interface 300 is an interface for enabling a user to select a channel to be received at the receiver section (not shown), to adjust the volume of sound to be outputted from the audio signal output section (not shown), or to execute luminance adjustment, white balance adjustment and the like of white light emitted from the backlight unit 140 which illuminates the color liquid crystal display panel 110. When the user performs, for example, luminance adjustment by means of the user interface 300, a luminance control signal is transmitted to the backlight drive control section 280 via the control section 270 of the drive circuit 200. The backlight drive control section 280, in response to the luminance control signal, changes the duty ratio of the pulse width modulated signal, for each of the red light emitting diodes 21R, the green light emitting diodes 21G and the blue light emitting diodes 21B, and performs drive control of each of the red light emitting diodes 21R, the green light emitting diodes 21G and the blue light emitting diodes 21B.

The arrangement and construction of the light sources 20 in the backlight unit 140 and the color liquid crystal display device 100 according to the above-mentioned embodiment of the present invention will be described below. It has been discovered from the intensive investigation and research conducted by the present inventors et al. that if lights emitted from the light sources are to be appropriately mixed in a limited space extending from the light sources 20 to the diffuser 141 in the backlight housing 120 mentioned above with reference to FIG. 4, under the condition that the angular radiation characteristics of the emitted lights are isotropic in a plane where the light sources are arranged, it is preferable to adopt arrangements able to satisfy the following conditions (1) to (3), because highest efficiency and uniformization of luminance and chromaticity can be achieved:

(1) an arrangement which places each of the light sources at a distance as far as possible from the adjacent ones;

(2) an arrangement which places light sources for the same kind of color at an interval as equal as possible with respect to a plurality of directions; and

(3) an arrangement which places all the light sources as symmetrically as possible.

The condition (1) will be described below. In the case where, for example, light emitting diodes are employed as the light sources, as the angular radiation characteristics of each of the light sources becomes closer to the horizontal, the proportion of light in its primary rays, which directly strikes the surfaces of the adjacent light sources, for example, the lenses of the adjacent light emitting diodes, and undergoes random variations in its ray trajectories, increases. As mentioned above, such proportion can be minimized by spacing each of the light sources as apart as possible from the adjacent ones. In addition, even when the angler radiation characteristics is approximately isotropic, it is possible to minimize random variations which the reflection directions of light radiated at angles close to the horizontal undergo from the adjacent light sources.

More specifically, the number of light sources is selected, for example, on the basis of the luminance required for the desired display size of a liquid crystal display device. For this reason, in the case of a backlight unit having a conventional construction in which there is a large difference in density between different arrangement directions, particularly if the backlight unit is reduced in thickness, it is likely that luminance nonuniformity becomes a problem.

On the other hand, in the case of the construction according to the embodiment of the present invention, light sources are spaced apart from one another in two or more directions in a plane where the light sources are arranged, so as to uniformize the density of the light sources in a so-called two-dimensional manner, so that luminance nonuniformity can be remarkably suppressed. The term “two or more directions” used herein includes not only mutually orthogonal directions like x-y coordinates but also an oblique direction makes an angle of, for example, 60° with one direction. For example, in a backlight unit used in a 32-inch liquid crystal display device, if an area in which to arrange light sources is a rectangle approximately 42 cm in length and approximately 70 cm in width, approximately 400 light emitting diodes are needed to obtain luminance preferable for the display device, although the number of light emitting diodes depends on the characteristics of liquid crystal devices and light sources such as light emitting diodes. These light emitting diodes are disposed so as to be spaced as apart as possible from the adjacent ones in a two dimensional manner, so that it is possible to remarkably improve luminance nonuniformity compared to the related art. In order to make the density two-dimensionally far more uniform, it is desirable to make the distance between each of the light sources approximately equal in two or more directions. However, if an equal distance is difficult to ensure in all directions owing to various factors such as a wiring structure, the ratio of the longest distance to the shortest distance from among the distances between each of the light sources and adjacent other light sources in two or more arrangement directions may be set to a ratio between 1 and 2, so that it is possible to realize satisfactory uniformization of luminance compared to the related art.

The condition (2) will be described below. Particularly in the case where light sources for two or more colors are used, as an area in which to mix the colors (an illumination area), i.e., a backlight unit, becomes smaller in thickness, the spread of the transfer function of light intensity in the area becomes narrower, so that an area which can be illuminated by one light source becomes narrower. As a result, such a backlight unit more remarkably shows a tendency that in the direction in which the distance between light sources for the same kind of color is smaller, there occurs a location where the light intensity of the color is stronger, whereas in the direction in which the distance between light sources for the same kind of color is wider, there occurs a location where the light intensity of the color is weaker. Accordingly, if such tendency is to be minimized to obtain the uniformity of luminance, it is desirable to make the distance between each of the light sources for the same kind of color as equal as possible with respect to a plurality of directions.

Accordingly, in any of the embodiments of the present invention, each light source for one color is arranged adjacently to light sources for the other colors and light sources for the same color are spaced as apart from one another as possible, and the light sources for the same color are approximately cyclically arranged in one or more direction so that the distance between each of the light sources for the same color can be made approximately equal. The term “approximately cyclically arranged” indicates that a multiplicity of (approximately several hundred) light sources are arranged in a certain constant cycle in the backlight unit. However, even if, for example, approximately at least several percent of the light sources are arranged at locations deviating from a cyclical structure owing to conditions resulting from the above-mentioned wiring structure or other conditions resulting from columns or a heat radiation structure provided in the backlight unit, the advantages of the embodiments of the present invention can be similarly obtained. Accordingly, the present invention is to be construed to encompass such a construction.

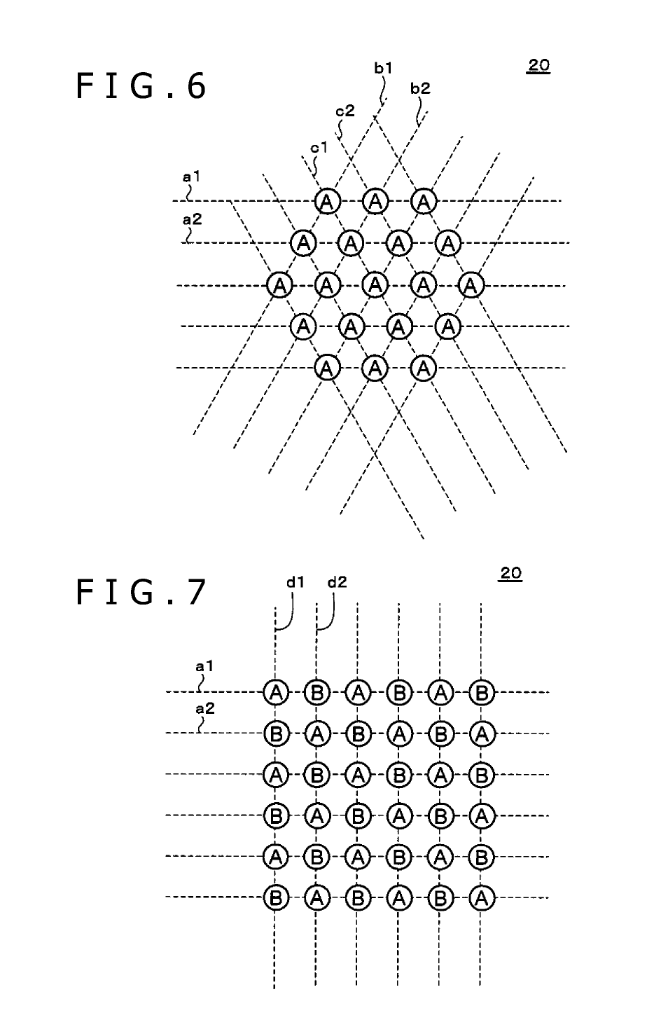

The condition (3) is intended to arrange light sources so as to satisfy the conditions (1) and (2), so that not only the uniformity of luminance but also the uniformity of chromaticity can be improved. Specifically, light sources are arranged in, for example, a triangular pattern or a grid-like pattern so as to constitute an arrangement construction which satisfies the conditions (1) to (3). In the above description of each of the arrangement constructions, reference has been made to a plane construction as viewed from the exit surface side of the backlight unit, but the light sources may also be arranged in approximately the same plane or with different heights in the height direction of the light sources, i.e., a direction perpendicular to the plane in which the light sources are arranged. The embodiments of the present invention will be more specifically described below with reference to FIGS. 6 to 13.

### First Embodiment

FIG. 6 is a schematic plan view of the construction of a main section of the backlight unit according to a first embodiment of the present invention. In this embodiment, the light sources 20 are arranged in a triangular pattern, i.e., at approximately equal intervals in three directions, one of which is an arrangement direction extending laterally as shown by dashed lines a1, a2, . . . , in FIG. 6, another of which is an arrangement direction extending obliquely at an angle of approximately 60 degrees relative to the lateral arrangement direction as shown by dashed lines b1, b2, . . . , in FIG. 6, and the other of which is an arrangement direction extending obliquely at an angle of approximately 120 degrees relative to the lateral arrangement direction as shown by dashed lines c1, c2, . . . , in FIG. 6. FIG. 6 shows a case where light sources for emitting light of one kind of color A, for example, white light emitting diodes or light emitting diodes for another color, are used as the light sources 20. In the case where the light sources 20 for the one kind of color A are used, the light sources 20 can be spaced as apart as possible from one another in a given area and arranged at equal intervals in the respective arrangement directions by a method of arranging the light sources 20 in an equilateral triangular pattern in the manner of the first embodiment. This construction makes it possible to remarkably suppress luminance nonuniformity compared to the conventional case where light sources such as light emitting diodes are arranged on a substrate extending in one direction.

### Second Embodiment

FIG. 7 is a schematic plan view of the construction of a main section of the backlight unit according to a second embodiment of the present invention. In this embodiment, the light sources 20 are arranged in a square grid-like pattern, i.e., at approximately equal intervals in two directions, one of which is an arrangement direction extending laterally as shown by dashed lines a1, a2, . . . , in FIG. 7, and the other of which is an arrangement direction approximately orthogonal to the lateral arrangement direction as shown by dashed lines d1, d2, . . . , in FIG. 7. FIG. 7 shows a case where light sources for emitting two kinds of color lights A and B, for example, light emitting diodes for two colors selected from among red, green, blue and white, are used as the light sources 20. The ratio of the used numbers of the light sources 20 for the two colors is 1:1, and the light sources 20 for the colors A and B are arranged so that each of the light sources 20 for either one of the colors A or B is arranged adjacently to the light sources 20 for the other. In the case where the light sources 20 for the two kinds of colors A and B are used, the light sources 20 can be spaced as apart as possible from one another in a given area and arranged at equal intervals in the respective arrangement directions by a method of arranging the light sources 20 in a square pattern in the manner of the second embodiment. This construction makes it possible to remarkably suppress luminance nonuniformity compared to the conventional case where light sources such as light emitting diodes are arranged on a substrate extending in one direction, and further makes it possible to suppress color nonuniformity.

### Third Embodiment

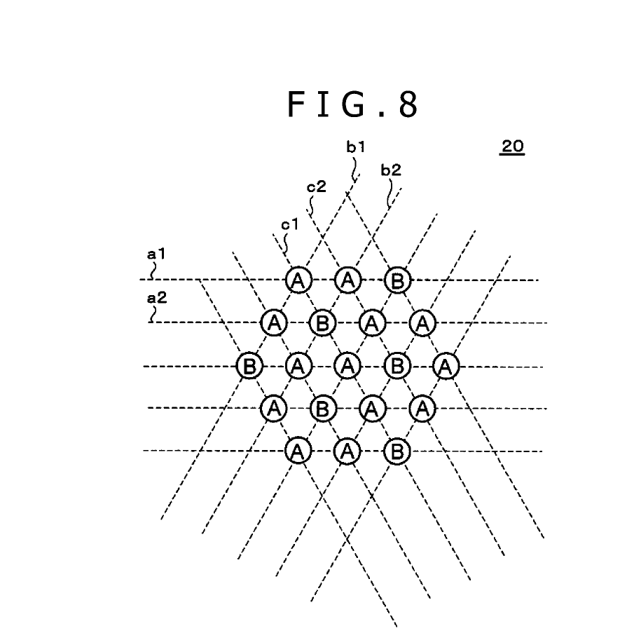

FIG. 8 is a schematic plan view of the construction of a main section of the backlight unit according to a third embodiment of the present invention. In this embodiment, the light sources 20 are arranged in a triangular pattern, and in FIG. 8, identical reference numerals are used to denote sections corresponding to those shown in FIG. 6 and the description of the same sections is omitted. FIG. 8 shows a case where light sources for emitting two kinds of color lights A and B are used as the light sources 20 and the used numbers of the light sources 20 for the respective colors A and B are set to a ratio of 2:1. In addition, in the case where light sources for two or more kinds of color lights are used, the optimum ratio of the used numbers of the light sources is not necessarily 1:1 and is influenced by visibility to each of the colors. Depending on the kind or number of colors, the optimum ratio need not be limited to 2:1 and may also become 3:2, 4:3 or the like. In this embodiment, the light sources 20 are arranged in a repetition cycle of A-A-B in three different directions by way of example. In this arrangement, the light sources 20 for the color B are cyclically arranged at approximately equal intervals in the respective three directions, while the light sources 20 for the color A are arranged away from each of the light sources 20 for the color B by an equal distance in all directions. Referring to, for example, the light source 20 for the color A arranged at the intersection of the dashed lines a1, b1 and c1, the light source 20 for the color A is an equal distance away from the adjacent light sources 20 for the same color in two directions respectively extending along the dashed lines a1 and b1, but is approximately twice the distance away from the adjacent light source 20 for the same color in a direction extending along the dashed line c1 as compared with the light sources 20 for the color A arranged in the other directions. In this case as well, color uniformity can be satisfactorily improved compared to the related art. This construction makes it possible to prevent luminance nonuniformity and efficiently mix two colors in two or more directions, thereby suppressing color nonuniformity compared to the related art.

### Fourth Embodiment

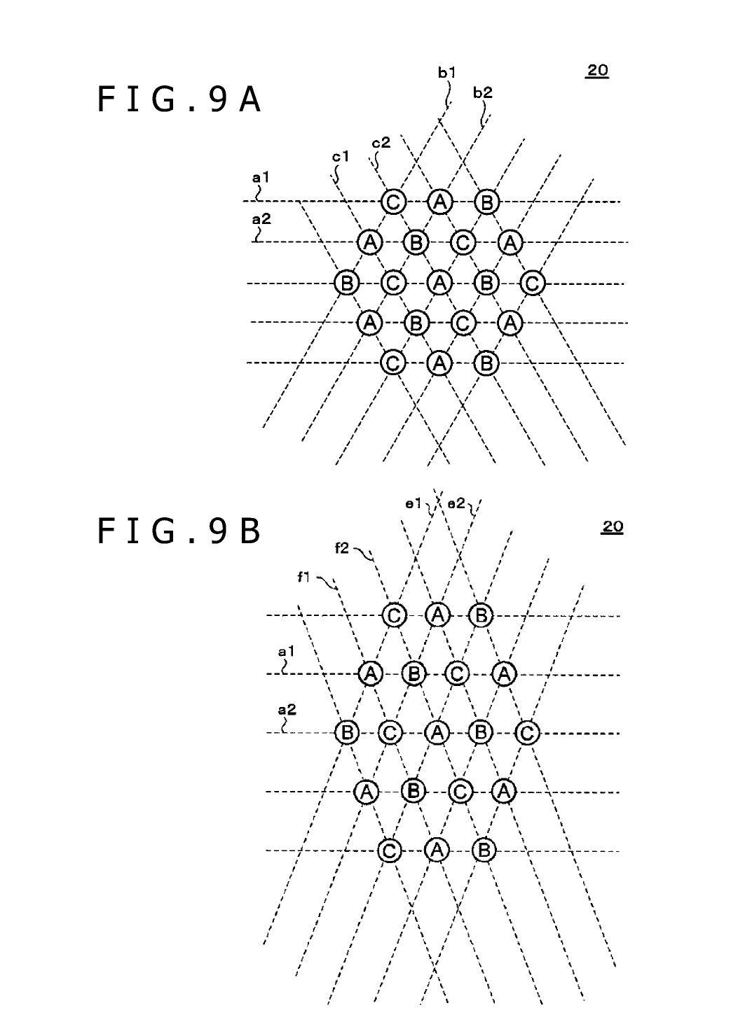

FIGS. 9A and 9B are schematic plan views respectively showing different examples of the construction of a main section of the backlight unit according to a fourth embodiment of the present invention. In this embodiment as well, the light sources 20 are arranged in a triangular pattern, and in FIGS. 9A and 9B, identical reference numerals are used to denote sections corresponding to those shown in FIG. 6 and the description of the same sections is omitted. Each of FIGS. 9A and 9B shows a case where light sources for emitting three kinds of color lights A, B and C, for example, red, green and blue light emitting diodes, are used as the light sources 20 and the used numbers of the light sources 20 for the respective colors A, B and C are set to a ratio of 1:1:1. FIG. 9A shows a case where the light sources 20 are arranged in an equilateral triangular pattern. Each of the light sources 20 for any one of the colors A, B and C is arranged adjacently to the light sources 20 for the other colors, and the light sources 20 for the same color are arranged at equal intervals, so that luminance uniformity and color uniformity can be extremely improved. FIG. 9B shows a case where the light sources 20 for the three colors A, B and C are arranged in an isosceles triangular pattern. The light sources 20 for the colors A, B and C are arranged in three directions, one of which is an arrangement direction extending laterally as shown by the dashed lines a1, a2, . . . , in FIG. 9B, another of which is an arrangement direction extending obliquely at an angle of approximately 70 degrees relative to the lateral arrangement direction as shown by dashed lines e1, e2, . . . , in FIG. 9B, and the other of which is an arrangement direction extending obliquely at an angle of approximately 110 degrees relative to the lateral arrangement direction as shown by dashed lines f1, f2, . . . , in FIG. 9B. The light sources 20 are arranged at approximately equal intervals in the direction shown by the dashed lines a1, a2, . . . . In this case as well, each of the light sources 20 for any one of the colors A, B and C is arranged adjacently to the light sources 20 for the other colors, and the distance between each adjacent one of the light sources 20 for the same color is selected so as to make the longest distance not greater than twice the shortest distance, so the luminance uniformity and color uniformity can be satisfactorily improved.

### Fifth Embodiment

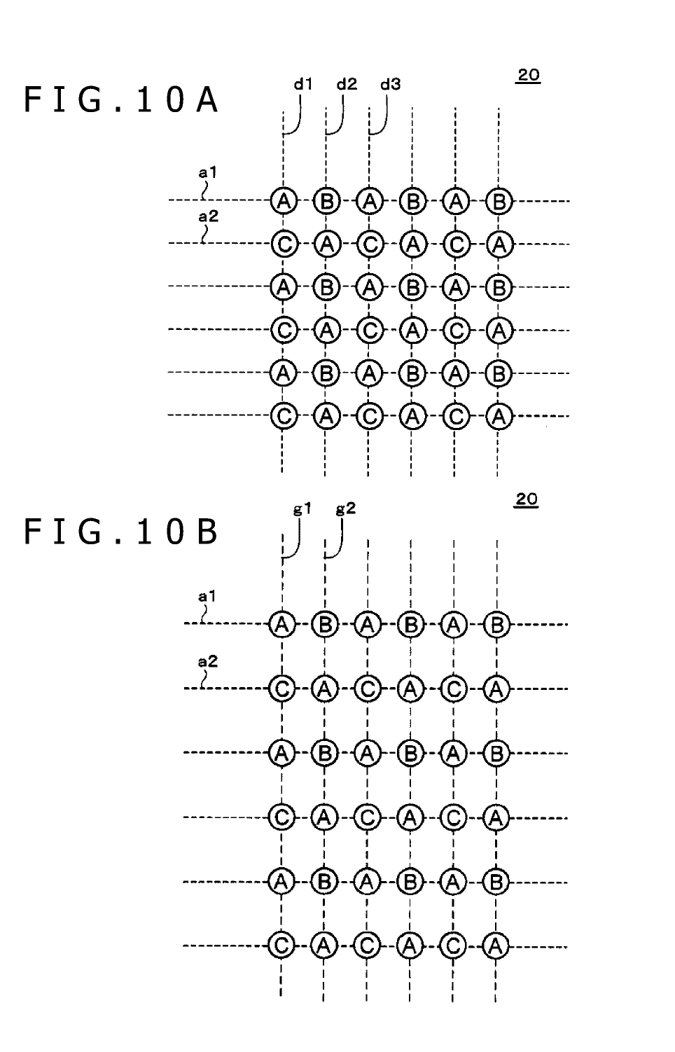

FIGS. 10A and 10B are schematic plan views respectively showing different examples of the construction of a main section of the backlight unit according to a fifth embodiment of the present invention. In this embodiment as well, the light sources 20 are arranged in a grid-like pattern, and in FIGS. 10A and 10B, identical reference numerals are used to denote sections corresponding to those shown in FIG. 7 and the description of the same sections is omitted. Each of FIGS. 10A and 10B shows a case where light sources for emitting three kinds of color lights A, B and C, for example, red, green and blue light emitting diodes, are used as the light sources 20 and the used numbers of the light sources 20 for the respective colors A, B and C are set to a ratio of 2:1:1. FIG. 10A shows a case where the light sources 20 are arranged in a square pattern. Each of the light sources 20 for the color A is arranged adjacently to the light sources 20 for the other colors Band C in directions respectively extending along dashed lines a1, a2, . . . , and dashed lines d1, d2, . . . , whereas each of the light sources 20 for either one of the colors B or C is arranged adjacently to the light sources 20 for the other colors in all directions, and the light sources 20 for the other colors A, B and C are arranged at equal intervals. In this case as well, luminance uniformity and color uniformity can be extremely improved. FIG. 10B shows a case where the light sources 20 for the three colors A, B and C are arranged in a rectangular grid-like pattern. The light sources 20 for the colors A, B and C are arranged so that the distance between each adjacent one of the light sources 20 in lateral arrangement directions shown by the respective dashed lines a1, a2, is made not greater than twice the distance between each adjacent one of the light sources 20 in longitudinal arrangement directions shown by the respective dashed lines g1, g2, . . . . Similarly to the example shown in FIG. 10A, the example shown in FIG. 10B can satisfactorily suppress luminance nonuniformity and color nonuniformity compared to the related art.

### Sixth Embodiment

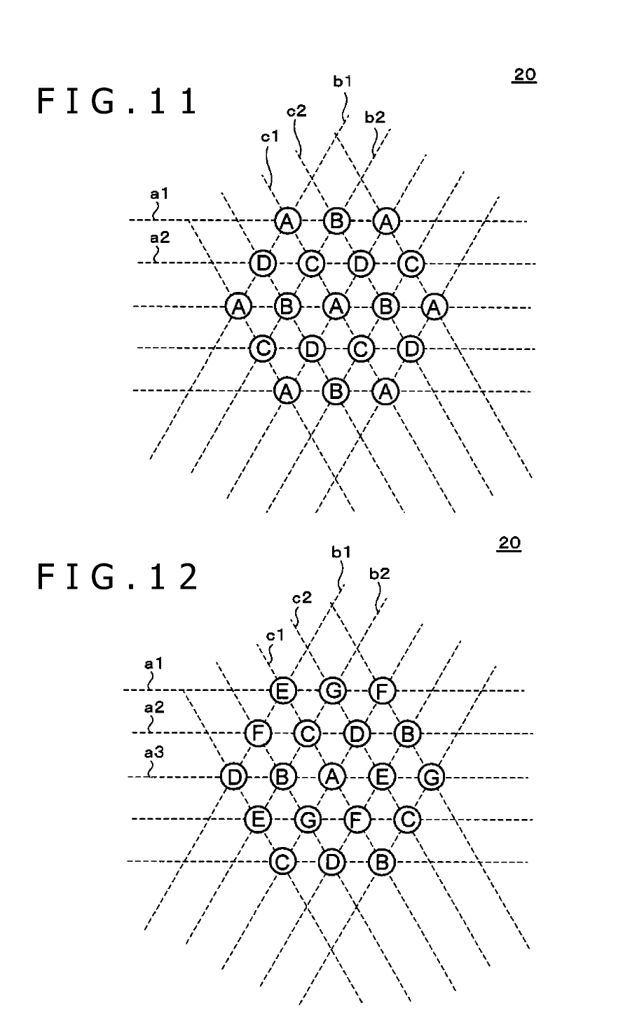

FIG. 11 is a schematic plan view showing the construction of a main section of the backlight unit according to a sixth embodiment of the present invention. In this embodiment as well, the light sources 20 are arranged in an equilateral triangular pattern, and in FIG. 11, identical reference numerals are used to denote sections corresponding to those shown in FIG. 6 and the description of the same sections is omitted. FIG. 11 shows a case where light sources for emitting four kinds of color lights A, B, C and D are used as the light sources 20 and the used numbers of the light sources 20 for the respective colors A, B, C and D are set to a ratio of 1:1:1:1.

In this embodiment, each of the light sources 20 for any one of the colors A, B, C and D is arranged adjacently to the light sources 20 for the other colors and the light sources 20 for the same color are arranged at equal intervals, so that luminance uniformity and color uniformity can be extremely improved. Examples of the light sources for emitting four kinds of color lights are as follows. In the case where light sources for the three primary colors, for example, are used, if three colors which cover the widest area of the xy chromaticity diagram are selected as the three primary colors, the colors contained in the area of a triangle which connects the points of the three colors on the chromaticity diagram can be reproduced, but colors surrounding the circumference of this triangle area cannot be reproduced. However, if the colors outside of the triangle on the chromaticity diagram are added, a far wider color reproducibility can be obtained. For example, if light sources for emitting colors such as cyan, magenta and yellow are added to red, green and blue light sources, a far wider range of colors can be reproduced. Accordingly, by adopting the arrangement shown in FIG. 11, it is possible to improve luminance uniformity and color uniformity, and if light sources which are designed to allow for the above-mentioned chromaticity are used, it is possible to provide a backlight unit and a liquid crystal display device both of which can be improved in color reproducibility.

### Seventh Embodiment

FIG. 12 is a schematic plan view showing the construction of a main section of the backlight unit according to a seventh embodiment of the present invention. In this embodiment, the light sources 20 are arranged in an equilateral triangular pattern, and in FIG. 12, identical reference numerals are used to denote sections corresponding to those shown in FIG. 6 and the description of the same sections is omitted. FIG. 12 shows a case where light sources for emitting seven kinds of color lights A to G are used as the light sources 20 and the used number of the light source 20 for each of the colors A to G is set to approximately the same number. In this embodiment, each of the light sources 20 for any one of the colors A to G is arranged adjacently to the light sources 20 for the other colors and the light sources 20 for the same color are arranged at equal intervals, so that luminance uniformity and color uniformity can be extremely improved. For example, if light sources for emitting seven colors such as white, red, green, blue, cyan, magenta and yellow are used as the light sources 20, it is possible to improve luminance uniformity and color uniformity, and if light sources which are designed to allow for the above-mentioned chromaticity are used as in the case of the above-mentioned sixth embodiment, it is possible to provide a backlight unit and a liquid crystal display device both of which are superior in color reproducibility.

### Eighth Embodiment

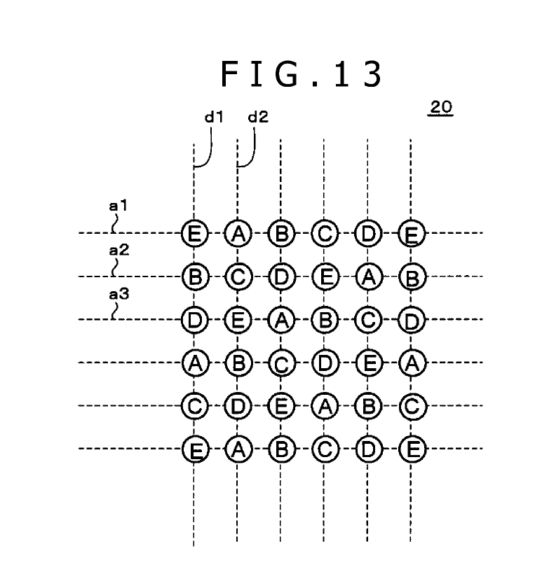

FIG. 13 is a schematic plan view showing the construction of a main section of the backlight unit according to an eighth embodiment of the present invention. In this embodiment, the light sources 20 are arranged in a square grid-like pattern, and in FIG. 13, identical reference numerals are used to denote sections corresponding to those shown in FIG. 7 and the description of the same sections is omitted. FIG. 13 shows a case where light sources for emitting five kinds of color lights A to E are used and the used numbers of the light sources 20 for the respective colors A to E are set to a ratio of 1:1:1:1:1. Each of the light sources 20 for any one of the color lights A to E is arranged adjacently to the light sources 20 for the other colors in all directions, and the light sources 20 for each of the color lights A to E are arranged at equal intervals. In this case as well, luminance uniformity and color uniformity can be extremely improved. In addition, in the case where the used numbers of light emitting diodes for, for example, red, green and blue are set to a ratio of 2:2:1, the colors A and B, the colors C and D, and the color E may be respectively arranged by using red light emitting diodes, green light emitting diodes and blue light emitting diodes. By adopting this construction, it is similarly possible to provide a backlight unit and a liquid crystal display device both of which are suppressed in luminance nonuniformity and color nonuniformity and have preferable characteristics.

As described hereinabove, according to the embodiments of the present invention, it is possible to realize uniformization of luminance in a backlight unit and a liquid crystal display device using the same, and it is also possible to realize uniformization of chromaticity in the case where light sources for two or more colors are used. Accordingly, it is possible to suppress the occurrence of luminance nonuniformity and color nonuniformity which could have been a drawback in the conventional arrangement construction of light sources in the case where a backlight unit is reduced in thickness, so that it is possible to promote reductions in thickness of backlight units and liquid crystal display devices.

In addition, according to the embodiments of the present invention, the shortest one of the distances between light sources which generate heat, for example, light emitting diodes, can be made large compared to the related art, so that it is possible to average heat and increase the efficiency of heat radiation. In addition, the increase of the heat generation efficiency makes it possible to increase the light emission efficiency of light emitting diodes.

The present invention is not limited to any of the above-mentioned embodiments, and can use various other light sources, for example, various types of light emitting diodes and other point-like light sources, and light sources such as fluorescent lamps. In addition, it goes without saying that various changes and modifications can be made as to various other constituent elements in each of the backlight unit and the liquid crystal display device without departing from the spirit and scope of the present invention.

It should be understood by those skilled in the art that various modifications, combinations, sub-combinations and alterations may occur depending on design requirements and other factors insofar as they are within the scope of the appended claims or the equivalents thereof.

The present invention contains subject matter related to Japanese Patent Application JP2005-130084, filed in the Japanese Patent Office on Apr. 27, 2005, the entire contents of which being incorporated herein by reference.

What is claimed is:

1. A backlight unit comprising:
light sources being arranged to be spaced apart from adjacent other light sources in two or more arrangement directions in a plane where the light sources are arranged.

2. The backlight unit according to claim 1,
wherein the light sources are arranged, in two or more directions, at a ratio such that a longest distance between each of the light sources to a shortest distance between each of the light sources is between 1 and 2.

3. The backlight unit according to claim 1,
wherein the light sources comprises light sources for emitting two or more colors, and each adjacent light sources is arranged to emit a different color.

4. The backlight unit according to claim 3,
wherein from among the light sources for emitting the respective colors, light sources for emitting same color are approximately cyclically arranged in one or more arrangement direction.

5. The backlight unit according to claim 1,
wherein the light sources are arranged in a triangular pattern.

6. The backlight unit according to claim 1,
wherein the light sources are arranged in a grid-like pattern.

7. The backlight unit according to claim 1,
wherein the light source is a light emitting diode.

8. A liquid crystal display device, comprising:
a transmissive type of liquid crystal display panel; and
a backlight unit for illuminating the liquid crystal display panel on a back side thereof,
wherein light sources are arranged in the backlight unit to be spaced apart from adjacent light sources in two or more arrangement directions in a plane where the light sources are arranged.
